(19) United States
(12) Patent Application Publication
(10) Pub. No.: US 2015/0193438 A1
(43) Pub. Date: Jul. 9, 2015

(54) Video Factorization By Temporal Stability And Spatial Resolutions III

(71) Applicant: Zhong Yuan Ran, Edison, NJ (US)

(72) Inventor: Zhong Yuan Ran, Edison, NJ (US)

(21) Appl. No.: 14/504,338

(22) Filed: Oct. 1, 2014

Related U.S. Application Data
(60) Provisional application No. 61/925,628, filed on Jan. 9, 2014.

(51) Int. Cl. G06F 17/30; G06K 9/00; H04N 5/225; H04N 7/08; H04N 5/232

(52) U.S. Cl. CPC G06F 17/3028; G06F 17/30256; G06F 17/30268; G06F 17/3025; G06F 17/30277; G06F 17/30259; H04N 7/0806; H04N 5/23232; H04N 5/2258; G06K 9/00718; H04N 2209/048; G06F 2216/15; G06F 2216/05

(57) ABSTRACT

We cluster information in a video by similarity, and sort them by occurrence frequency and by temporal variation frequency. Temporal invariants are defined as information with temporal variation frequencies are substantially zero. These invariants are shared along temporal dimension of videos for data compression, information gaining. We judge some of the invariants as background.

Clustering also create structure in a videos. These clusters can be recognized from named objects, patterned relationship database and landscape database. With these recognized names and patterns, the structure of video can be serialized into natural language.

Background from multiple videos can then be merged and concatenated into large continuous backgrounds. Large quantity of outdoor video can form a landscape database with moving objects and people been removed. Overlapping background from different time allows for high variant portion of the background been identified for Lost and Found and intelligence gathering application.

Viewing point and viewing angle normalization, multiple resolution matching (and recoding) biased toward lower resolution preceding higher resolution are important technique to vastly improving opportunities of finding good matching. Viewing point and viewing angle normalization produce a set of discrete viewing points and viewing angles, where information from different viewing point and viewing angles are further shared.

This application claim the benefit of U.S. Provisional Patent Application No. 61/925628 filed on Jan. 9, 2014

### FIELD OF INVENTION

This application is related to video information processing and camera.

### BACKGROUND OF INVENTION

Visual information is one of the most important information we receive. But the capture and processing of these visual information is heavily influenced by accidental camera design of the past. Especially, videos and images are captured with uniform resolutions and processed with uniform resolutions. There are very little structures to video/image information. And information in videos are processed broadly biased toward image first, temporal information regularity come in as second though in state of the art video processing and coding.

### SUMMARY OF THE INVENTION

In this application, We try to create structures in video/image information. We design algorithm to cluster video information by similarity, and sort them by occurrence frequency, temporal variance frequency or time stability, and capturing, coding information according to these difference. We then compress video accordingly, transfer information between videos based on close camera locations, and build landscape database and object database accordingly. Finally, we design hardware to capture video/image with different resolutions specifically fit for this kind of video/image coding, processing and compression. In video compression, we can compress video/image into symbols and structured symbols, eventually connect video/image with natural language.

### DETAILS OF INVENTION

A Few Generic Themes of this Application.

There are a few themes throughout this application, Understanding these themes is very important in understanding this application.

Multiple Resolutions.

The same/similar information can be processed, captured with multiple resolutions. Video/Image information with multiple resolutions representation can be generated from the same raw information sources, or can be captured separately. These different resolution representations can be processed separately, or joined together. form an coherent whole. Different resolutions can feed processed information to each other for more refined processing. Examples: 1: a high resolution video can produce multiple copies of lower resolutions videos with reduced information size. 2: two cameras, one with 10 million pixels another with only 1 million pixels, capture the same scene at the same time.

Sorting by Information Variant Frequency.

Information once represented by a system, can be introspectively inspected, and the varying frequency of the information can very easily be observed. These difference in varying frequency is of great importance in this application. These information that does not change (zero frequency) are called invariants. Localized invariants for an particular session or scope of interest, are called context or background. The most important variation is variation over time. Time invariant is of the greatest importance for this application. For video, the timing information is inherent to the video from frame to frame. More and more video have extra timing information (absolute time) so different videos can be related in an time line for long term scale variation frequency sorting.

Transformations.

With good transformations we can drastically improve chances of find “matching”, “similarity”, “zero varying frequency”. So we should have a library of such transformations. Some simple transformations can do wonder: such as differentials. Lateral inhibition is in many ways can be interpreted as differentials b/w neighboring units. Temporal inhibition can also be interpreted as temporal self differentials. Differentials b/w lower resolution and higher resolution is also very common and “color constancy” is essentially the differentials b/w very low spatial resolution color information to high spatial color resolution information. Another transformation is of importance is “egocentricity removing transformation” (using perspective transformation to remove video changes due to perspective change). This transformation remove the information difference due to observation point and observation orientation differences. For video/visual information, egocentricity removing transformations are important because by performing this transformation, we can removing most of the information varying observed by a moving observer. In video application, we are specially interested in an simplified egocentricity removing transformation applicable to small viewing point and orientation changes. With certain approximation tolerance, small orientation and viewing point change can be transformed by image shifting, rotation and scaling etc, to produce good matches b/w frames on the background part of the images. These “good matches” are time invariant for a given video session. Perspective transformations are well established technology in graphic manipulation. This transformation can normalizing perspective of images for comparing and overlapping. In general, transformation can be applied to “normalize” input information so opportunities to find an “matching” in a database can be greatly enhanced.

Viewing point and viewing angle normalization: In before section, this transformation are sometime called: viewing point and viewing angle difference removing transformations, viewing point and viewing angle converging to an anchor point and angle. The essence is to remove differences caused by small viewing point and angle change of the camera. This camera motion explains largest amount of “information” in video, which have very little new “true” information. These transformation in theory are functionally similar to matrix based 3D camera moving in a 3D virtual world, except, we do not have an 3D model to begin with. So practically these involves heuristic transformation guessing viewing point and viewing angle changes, and optimizing for a set of transformations that reduce the difference between two images the most.

Clustering and Sorting

Clustering can be done by temporal clustering and temporal sequencing, by periodicity, by spatial clustering and spatial patterns. It can be done by an kind of similarity measurement. Clustering can be done by shared invariants (context). Through clustering we can create identities. Through sequencing and patterns we can create relationships. Through shared invariants, we can create “a session”, “an organized whole”, and “a coherent system”. Most invariants are not universal invariants so they mark boundary of “an organized whole” in the scope and duration while they are invariants.

Clustering involving judgement of similarity. In video and images, these judgement are done with image size (image of the video frames) and orientation normalization in today's state of the art and assumed to be performed whenever it's appropriate. In this application we focus on transformations specific to videos taken by a moving camera, where viewing point and viewing angles can change. This is an essential step in cross videos compression and information sharing, because two videos most likely have different viewing points and viewing angles. Without such transformation, matching opportunities between videos are hard to find.

The other technique in increase matching opportunities are using multiple resolutions to find matchings. In general lower resolutions of the same sources of information can produce much more matching opportunities, and the matching in lower resolution is in general much more robust and more stable, so it is preferred before higher resolution matchings.

Discretization.

Through inhibition we can form discretized entities that economically cover an receptive field. These receptive fields can be as concrete as: a spot on retina for photo receptors, a spot on skin for touch/pressure sensation, and can be much more abstract, such as an discretized viewing point.

Maps and Space, Isomorphic Relationships.

Discretized entities clustered together form “maps”, or “space”. the arrangement of these discretized entities form relative positions that have a degree of isomorphic fidelity to aspects of reality. Such that new relationships can be inferred by the relative positions on the map without direct experience. This is the generalized “short cuts inference” in spatial knowledge. Example: if A is close to the left of X, B is close to and to the left of X, then A and B most likely have a short cut between them in a low dimensional map such as 1D or 2D map, even without direct knowledge of relationship between A and B.

Linkage of Video/Image with Natural Language Representation.

After sorting the video and image contents into clusters, these clusters can be named. These name can be assigned by object identification methods. Supervised learning can be particularly effective to bootstrapping such named entity database. The structure of these named entities, the organization, templates, clustering of these named entities can also be identified. These named entities, their organizations, clustering and organization templates can then be serialized into natural language text. On the other hand, natural language text can be rendered into video and image by inverse the process: We can identify named entities in text, and translate them into image and video components, identify structures and templates in languages and matching them with known templates. These templates and structures can then be used to construct videos and images. So we can create video/image to natural languages bi-directional transformation algorithmically.

Iteration and Recursion.

The whole process is iterative and recursive. It is recursive so the generic principles can be applied again on again on larger and larger units build up organically. Concrete receptive fields (or entities) can join together to form more and more abstract receptive fields (concepts) to detect very high specificity patterns. These recursion can also form hierarchical database easily. Iteration also means we can bootstrapping the process from smaller set of data.

Put Them Together.

With these concepts, it is clear now to describe this application: an information source is sorted by variance frequency. The part did not change at all are called invariants. The part that only change very slowly are approximate invariants. In order to judge variance we must judge same/similarity. This same similarity judgement can improve positive yield (been same/similar) dramatically with transformations (especially normalization) and multiple resolutions processing. With similarity judgement it is easy to sort and cluster information. These clustered information then can be discretized into discrete entities. Entities arranged into maps to create relationships. These entities and relationships can then further related to established information, give this particular information sources a broad context. The entities thus formed in this information sources will connect with entities in established information sources creating “recognition”. This recognition can than make use of all the related information in the established information base. Any unrecognized entities can be added to this established information base together with the relationships with other establish information. This established information based will itself subject introspective processing by this same method, to sort frequent occurring invariants as deeply established knowledge, therefore creating structure within this information base.

Now we apply invariant extraction to video content. The invariant part of an video session are the background.

Video Background Extraction.

In an typical video session, the information on the background does not change, and most information change are in the figure or foreground, typically human or animal activities. But from frame to frame we see a lot of information changes. Most of these changes can be explained by the viewing point and viewing orientation changes of the camera. So we will apply egocentricity removing transformations to remove these changes. An exemplary implementation:

a) pick an frame, typically the first frame in an session, with its implied viewing point and orientation as anchor.

b) for any new frames, perform an egocentricity removing transformations to cancel out any changes due to viewing point and orientation changes from the chosen frame. this transformation can be judged by optimizing “matched-ness” on portion of the frame. We infer camera motion from the transformations performed.

c) if the final “matched-ness” satisfy an given threshold, This matching is accepted. The new frame (with its new viewing point and orientation) is converged to the chosen anchor in a). If can not be made to satisfy the given threshold, this frame and the implied viewing point and viewing orientation are then be chosen as new anchor (without transformation). The relative position of this new anchor with old anchor can be inferred by the transformations performed in b).

d) for all the frames that converged to a chosen anchor frame, after egocentricity removing transformations, must have good matches on portion of the frames. All frames overlapping with each other spatially but separate in an time line. For any given spatial point (can be a single pixel, or an cluster of pixels), we can sort information temporal variation frequency. The zero temporal variant part are the background.

I only included the essential part for clarity. There are many other heuristics can be applied. for example, background are biased on the edges then in the center, background are biased to form an connected region cover large area much like an swiss cheese while foreground form closures, The background from one anchor point will continue to be background in another anchor point. The background matching are likely “partial matching” in that the edges of frames are likely not aligned perfectly, and the moving figures are not likely to match very well. But we can always “grow” our matching from some well matched region outward to overcome this partial matching issue. But the emphasis here is “temporal variant frequency sorting” and temporal invariants extraction.

There is need to chose another “anchor” because 3D (real world) to 2D (most camera photo sensors) projecting is inherent information loosing. So large viewing point/orientation transformation will involve information losing and information invention at a degree exceed approximation tolerance. In another world, a chosen anchor points can only cover a nearby area. The size of the area depends on error tolerance, and resolutions of video/image. Multiple resolutions are used to extract background at different scales, and increase “matching” opportunities (more details later).

Any particular frame can be represented by an vector (viewing point, viewing orientation) on the time invariant part. Assuming the camera can turn around easily, the background part of the frames partially overlapping between different orientation. Turning around can also be clustered by temporal clustering. So we can further cluster all vectors (viewing point, viewing orientation) that share the same view point but different viewing orientations together to form an larger clusters the can be represented by (viewing point) along.

The exemplary implementation is trying to extract viewing point and viewing orientation information directly from video images. If the camera have additional information about viewing point and orientation such as GPS and other information, the algorithm can take advantage of these information.

With this background, the temporal invariant extracted from the video, we can compress this video session dramatically by reused this background in many frames. We can also take advantage to redundancy of information on this background to extract an background that have much higher resolution than any single frame of the video. So this is an “gaining” video compression algorithm. But most of all, we can do cross video data compression and information transfer.

Cross Video Data Compression and Information Transfer.

Up to this point, we only take advantage of the information within an single video session. Videos today have external information such as GPS location, date and time of recoding. We can also detect landmarks on the video, generic features of the backgrounds, to cluster different videos further. Once a collection of videos can be clustered to an same/nearby location, information on the background part of these videos are very likely to be mostly identical. This open the door to cross compress data between videos and transfer information b/w videos on the background(detected invariants) part of the video.

Some other factors come into play here. 1) lighting conditions may be different. But these lighting conditions can be easily inferred by statistics of the video, and by differencing the same scene from different videos. 2) camera specificity. Again this can be identified by similar methods. If there are only two videos, the distinction b/w lighting conditions and camera specificity may not easily distinguished. But with more and more video on the same scene, we can better distinct them. If many videos shared the same background, such as in hot tourist attractions, we do not need to keep the same background many times, we simply keep viewing point and viewing orientation information, lighting condition information of the time, and some camera specificity information, and render the background dynamically as needed from a copy of “shared” background information.

Because this background can collect information from many videos so it likely have much better quality and resolutions than most videos. This open the way to cross transfer information on the background part of the videos.

Concatenation of Backgrounds to Form very Large Physical World Database.

In the “turning around” of the camera, we can concatenate backgrounds with large overlapping part to form an whole much larger than any single frame. This method of concatenate partially overlapping background scenes from different videos can be extended to different scales to eventually form a large database that hold information of our physical world, on different resolution levels. This background can be even extended into indoor space, with private space for private use and public space for public use.

One issue in creating such database is privacy. Some application that record video of street scene and put them into public space. But these videos contain large amount of personal activities. This cause privacy concern in many countries. With our method, all variant part of information can be peeled off from the videos, so any personal activity are automatically removed from the scenes. Only the static background remains. This database will remove privacy concerns for such kind database.

Now that we have this static (more or less) database. By differencing, we can identify recent changes, novelty and exceptions. This have obvious application in intelligence gathering.

With known background, any new video can be compared with this background, again, by differencing, we can identify the moving objects, the people, animals, cars on the background easily and clearly. This method of object identification is superior because we first peel off the largest quantity of information, the background, so we can focus on the information of significance, the figures, the moving objects.

As wearable devices became more prevalent, as we put cameras on cars and enable sharing of videos from car and wearable devices, we are going to have very large video database to work on. So we can easily build this physical world database, to cross video compression and information transfer with 2, 10, 100, 1000, 100000, 1 million, 100 million, 1 billion, 100 billion and more videos and video sessions. So we can form an digital version of the world, especially for these places that are heavily trafficked by cars and by people. This digital version of the world have an stable component that is the “ground” can be concatenated to form an single, connected, coherent, continuous digital reality that is fairly time insensitive, or time invariant. On top of this ground we can have some more time sensitive information as they occur.

Two Way Connection between Language and Video

With physical world database, we can peer off background. With further clustering of the residual information, we can form new clusters represent objects, and have a database of such common objects. With this database, we can then represent these clusters and background using “symbols” or names. These named entities structured together to form the video/image. These structured named entities can be represented with natural language text. So we create connection b/w video/image with natural language text. Or we can create an text description of the video/image as extreme data compression algorithmically with these databases. Inversely, Given a text description, we can search and find the named entities, templates and structures, from our databases, and rendering an video/image accordingly.

Multiple Resolutions, Capture, Information Coding, Rendering.

Multiple resolution processing is an critical element in this application, without it it is very hard to generate stable matchings which is very important in clustering. Direct operate on high resolution are very easily get trapped in an “local optimal” matching given optimization are anticipated to have a major role in find good matchings. Even through we can generate lower resolutions version from higher resolution version. These multiple resolutions are not independent to each other, and the capturing of the high resolution version as the only first hand information is wasteful.

So we can design camera to specifically capture multiple resolutions if the same visual information. These cameras have at least two set of photo sensors, these sets are configured to have substantially different resolutions. Specifically, we care about viewing angle resolutions for the same viewing field. Because we are trying to produce one coherent video with multiple resolutions, we must try to put these two set of photo sensors as close as practically possible so they can have very close viewing angles. The practical implementation can be two cameras with different resolutions and preferably with different viewing angle width, with lower resolution camera having wider viewing angles. These two cameras are placed as close as can be with reasonable effort. These two cameras can be synchronized to help later processing, so we can have image frame by image frame relationship directly. Because low resolution camera typically consuming much less power, so we can control power on/off separately, with lower resolution camera be on for standby much more often. And the higher resolution camera to be triggered either by human or by an algorithm to determine information content (such as moving objects in sight) to bring up the higher resolution. Reader can think this higher resolution as “gaze” or focused vision, which needs “attention” form user (button), or from attention grabbing stimuli (moving objects).

The multiple resolution information are preferably packaged in a single video file or stream.

Video Session Demarkation.

Video session can be find out naturally by video file organization (typically one file for a session), by time continuity information (many videos have embedded time information as it was created) and by other demarkations. We can take advantage of these information in find invariants in a session, the largest part of this invariants can be judged as background. On the other hand, sharing of the background can be defined as video session marker. The breaking of background can be the marker of a video session ending, and the beginning of another session. Video session and background extraction therefore can bootstrapping and reenforcing each other.

Temporal Variation Frequency vs Time Stability vs Scope of the Information.

Time stability is inverse to temporal variation frequency. Stability of an cluster can be measured with how long this clusters stay basically the same. The sameness measurement can be done similar to image clustering judgement. If an cluster stay about the same in the time scope of consideration, its temporal frequency can be estimated as zero. This calculation does not need to be very precise. Just enough to discriminate information content into clusters. And we first pay attention the invariant clusters, peering off this cluster (assume it will be stable and persistent through out the scope of interest), then focus on the next cluster, and so forth.

Implementation Details of Video Context Extraction.

For easy of presentation, I call a set of transformations in video as “egocentricity removing transformations”. they include: removing of viewing point change, removing of small viewing orientation changes which mostly cause whole shifting and/or rotation of the image. Removing of camera specificity, this can be done if we have many videos from different cameras. Removing of lighting condition specificity, this can be inferred by the statistical natural of the images, location, weather, time etc. and also can be done by differencing videos from different time, by different cameras. Removing zooming/size and distance specificities, removing of any known distortions. By “removing . . . ” I mean to normalizing it for comparison. We may have global standard to normalizing large quantity of data to, or local standard to only compare two images and everything thing in between. An “point” where “nearby” conditions to normalize to, is called “anchor”. “Anchor” can be thought as a “center” nearby data points converge to reduce number of distinct data point. “Anchor” is a generic concept I use to reduce data points. In an particular operation, only some of the transformations are needed. In an single session, we do not have need to removing camera specificity. In short session where there is no significant lighting condition changes, lighting condition normalization is unnecessary. In statically mounted camera, viewing point and viewing orientation changes are unnecessary.

Once we did this “egocentricity removing transformations”, we are ready to do partial matching. I call it as “partial matching” to emphasis the effort to find partial good matches of the scene even there are other portion that is completely different.

If scene A matches very well with scene B on only left half, and does not match at all on the right half. This is still considered as good partial match. The quality of the match on the matched half dominate judgement of matching of the scene, while the un-matching part does not have much negative impact on the matched-ness of the scene as an whole.

Further more, this partial match put greater emphasis on the edge and surrounding of the scene than center. (this is in contrast to object identification). And it put greater emphasis on connected parts of the scene than discrete concave clusters, this is also an contradiction to object identification)

One implementation of “partial match” can be: starting from an region of “good match”, “grow” from this region by extending out from this region into adjacent region also have an “good match”, mark boundary on place where the “good match” ends. These matched region should form large area of connected regions. the “span” space of these matched region should be very large. “span” space is the extended outreach, or the area that needed to “contain” the region, not the actual area. An example of an large span space with significantly small actual area will be an piece of swiss cheese. While in an single frame, the background may have an “swiss cheese kind topology, as figures move, these holes due to occlusion will be filled by other frames so are likely form an continuous background without hole. If there are still any “hole” left, other videos taken from the same scene can fill the holes. As more videos accumulate, we are likely have fewer and fewer “holes”.

“good match” need to join two factors: matched-ness and specificity of the region. Two blank space may have perfect matched-ness, but because blank space have very little information, therefore very low specificity score, may not considered as “good match”. So “landmark” are regions that have high specificity scores therefore are ideal candidates for “good match”.

With this kind match, we can extract an stable background that is the “context” of the video and can be the context of any other video for the place with similar view point and orientation. With this background, we can then identify exceptions from this background as objects and motions.

Temporal sorting for an given point: The background will be static. But occasional occlusion of foreground objects can block the view of the static background. But the foreground portion are unlikely static so they consisting of the variant part of the information. The static back ground form an very “tight” cluster” (“tight” means have very high similarity scores) in many frames. One way to implement is to inspect all the “tight clusters”, and pick the one with the most data points. In addition, the time span of these data pints are very important. With large time span for these data points indicate very strongly that the cluster represent invariants. time span can be inferred by frame sequence and by other means such as direct time records.

For vehicle application, we can have cars mount camera(s) that take video continuously. Join videos taken by different cars and/or at different time, by our method we can remove high frequency component of information: all movable and transient objects. Leaving only the low or zero frequency information, the fixed terrain, landscape, and fixed structures to join to form a background where all movable objects can be isolated and recognized clearly. There are natural synergy: automobiles are the ideal vehicle(abstract) to mount cameras, because they follow repeated routes (many cars run on a single motor way), with highly predictable viewing orientation and directions (driving directions) and having precise location information (GPS or similar), and have ample power and storage space for mobile application. But most of all, these information is highly relevant to automobile safety and automation.

Repeated videos at different time, from about same but slightly different view angles, with precise location information, with natural separation of movable objects vs static background, make this method particularly easy to implement on automobiles. And knowing its environment, especially terrains and moving objects around it is of vital importance for vehicles.

Temporal variation frequency is very intuitive in videos because the time continuity nature of this information. For image in isolation, temporal variation is difficult to come by. But no image exists in isolation. An image frame cam exist in the context of an video, with many similar image frames in sorted in a time line. An image can also exist in a database in the context of many other videos and images taken from same/similar locations. These context give us ability to extract time variation frequency information for an image. But of course, videos are one of the easiest to work with, and most likely the starting point to bootstrapping the process.

Lost and Found Application, Novelty, Newness, Alterations. Negative Information Coding.

One of the use for indoor-scape will be as an “lost and found” application. We can take an camera scan an indoor space, next time if we forget where things are, we can scan the same indoor, and this application can identify where there are “changes” b/w these two or more scans, and these “changes”, or the “high variant” portion of the background are where the “lost” stuff are most likely are. Static images can substitute video as an degenerated application, with reduced scope in general.

“High variant” part of an background is in general “medium variant” information in a video/images. They typically have lower variation frequency than moving objects and people and animals in the video therefore these merged background will have people and automobiles removed. This is good for information because people who look at the landscape information do not want accidental vehicles block the view. But more importantly, these information have privacy issue should not have permanent record to begin with.

In general “high variant” part of an environment are where the “interest” are. This is broadly true. We call them as “novelty”, “trend”, “new”. By our method we can identify novelty easily. The invariant part of our knowledge can accumulate almost infinitely, but they subside away from our conscious attention unless they are broken. This is a kind of “negative information coding” that is most economical for such invariants: the break or absent of such invariant is information.

This also have implication in intelligence gathering in large scale landscape and world-scape database.

Physical World Database Implementation Issues.

1: lighting conditions, glowing and glistering.

When we cluster images and frames of videos, we can match and merge images. But some times, lighting conditions changes can be dramatic such that these differences need to be processed specially. One of these condition changes are day light vs nigh light. and the images taken under these two conditions, even for the same spot with same viewing orientations can be very different to the point generic “similarity of images” would be very ineffective. In these situations we can first clusters images by lighting conditions crudely. Other information, such GPS location can be used to further cluster them together with an very strong bias to “seeking” similarity out of two drastically different images.

Similar situation could happen when there are glistering and glowing elements in the image/videos. Glowing and glistering in general can be identified by lacking of color constancy. This lacking of color constancy can be easily detected for non-dramatic lighting condition changes, especially for an video that experience continuous lighting condition changes such as cloud passing.

Glistering and glowing are visual exceptions for human evolutionarily, but have become common in modern cities. It is an high variant information element that is actually part of an static background. In actual implementation, we can using high specificity procedures to seek them out and include them into the context, the background. We can have an certain protocol to code such exception, for example, glistering can be a kind of color, rendered by an special procedure that have temporal element or contingent to lighting conditions. These are important to get city scape and street scape and indoor scape working properly. For automobile application, lightings have special meaning as dictated by traffic laws and can be coded into high specificity procedures.

2: Grid structure of anchor view points, ad hoc, dynamic, or given a priori.

These grid structure of anchor view points and orientations can be dynamically formed, depends on data availability and density, temporal sequence of data, where earlier data providing an “first sight bias” in establish of grid especially for stream media. But they can be given a priori from a grand schema, these grand schema can be designed when we plan to create a large database of the natural landscape and terrain information database. The grand schema are also called “architect” for large information system, or “schemata” by Kant.

This application is part of an iterative process, so some information may not presented in a strict linear form. Readers are encouraged to read a few times. The application is more clear to keep this in mind.

Further Clustering of Video and Image.

In an generic sense, context is part of the video that is substantially invariant relative to other parts of the video. So in a more generic way, we can sort videos and images by degree of constancy, duration of constancy, appearance frequency. Then we can peer off information cluster by cluster, with the most invariant (therefore most predictable) parts been peered off first, then focus on the residual information after that. So the foregrounds and the objects are the residuals of peering of stable context information. After some invariants have been identified, such identified invariants give us an strong bias to what the remainder information should be. This bias are additional information narrow down possible choices and boost confidence of recognition of the residual information. These bias can be generated from the database we collected. We can iteratively apply this method to layer by layer reduce unidentified information. And each good recognition also re-enforce previous recognitions in this iterative process.

Representing Clusters and Pattern of Relationship with Natural Language Text.

So we can build a database of such clusters. And with supervised learning and other recognition methods, naming such clusters. Such naming can use natural language names. We can also further cluster such named entities, by in the same video, by close to each other in the same video, by similarity in relationship in the videos. We can further build a database of patterns and organization of such named entities, and learning to assign names to them, such names can take from natural languages. We can further identify relationships b/w named entities, structures formed by named entities. And name such relationships. We can further serialize these organizations and structures into natural language text. This way we can convert a video/image into natural language text content. This is a drastic compression of video content.

This approach is functionally similar to object recognition, but with a few critical differences: We do clustering first. So it is better named as “object construction”. This fit our mental experience much better in that, we do first organize our visual experience into sensible clusters, then name it, rather than accept extra-experience objects first then try to recognize them in experience. The later approach is very unnatural but is the dominant and state of the art in machine vision. We do “object construction” first, recognize later.

The other difference is that we do not have an “object centrical” approach to visual perception. We adapt an holistic and iterative process, peel off the most stable and largest raw quantity information first, by extracting background away, and assuming they are stable going forward so we can focus on the less stable information, such as people or animals. The background is not less important in our visual perception, we spend less resources to process them simply because we take advantage of information stability nature of background, therefore the sorting of temporal variation frequency, and the invariant nature of background in the scope of consideration.

Some of the patterned relationship can be: A is next to B, A is inside B, A is bigger than B etc. Recognizing these relationship is straightforward. Once recognized, this relationship can be represented in natural language.

Multiple Resolution Image Capture.

Because each component in an video have different significance, different level of stability, different level of persistency, they deserve different level of information resolution. For example, horizon in an outdoor video on an moving carrier, is much more stable and persistent than near scene, therefore deserve higher resolution of information in rendering. Also, because of the redundant nature of the information background, we can afford to capture low resolution information, and recover high resolution from redundant information. But the foreground information, especially the moving objects have very little redundancy so deserve high resolution capture. These foreground figures are also in general unique to this particular video/image, so less likely to get information transfer from other videos, so we need to devout more resources to capture these information.

So we can design camera on this insight. We design a set of video/image capture devices with different resolution and viewing angles. Such captured information can coherently form an whole video/image.

Specifically, we can use a low resolution, wide angle video/image capture device, join with an narrower angle, high resolution video/capture device, from substantially same viewing position (by putting them very close together, or even packages in a same housing). These video/image are synchronized to synthesis a single video in rendering. Multiple resolution rendering is very natural. In fact, many art rendering natural scenes that have very high resolutions on horizon than near scene, higher resolution on figures than background, and higher resolution on face than body, higher resolution on eyes than other parts of the face.

Low resolution camera are also more power efficient and consume much less storage. So they can have very good “stand by” function, activation of camera just turn on the high resolution component of this kind camera.

The package of multi-resolution sensors can vary. In the most integrated form, we can package multiple resolutions on a single surface, similar to retina of the eye, where the center are packages with high density, high resolution photo receptors, while the periphery are packaged with low resolution lower density photo receptors. A less integrated solution will have “layered structure”, where a small, high density sensor matrix layered on top and center of an larger, lower density sensor matrix. We can have more than two layers. This design can share a same aperture. In yet another less integrated solution, two distinct devices can be packaged very close to each other, such that from an normal camera operating distance, they can be approximated as from a single viewing point. There may be a very small parallax effect, but can be compensated by processing. This last method is the easiest to implement.

Languages and Comments for the Claim:

Sharing of background: if two background have large overlapping portion, sharing them have the obvious advantage of data compression. But sharing also can have information gaining: when merging many copy of the same background, using statistical methods can extract a shared copy of the background that have more information than any single copy, therefore produce information gaining and information transfer.

Viewing point and viewing angle normalization. In before section, this transformation are sometime called: viewing point and viewing angle difference removing transformations, viewing point and viewing angle converging to an anchor point and angle. The essence is to remove differences caused by small viewing point and angle change of the camera. This camera motion explains largest amount of “information” in video, which have very little new “true” information. These transformation in theory are functionally similar to matrix based 3D camera moving in a 3D virtual world, except, we do not have an 3D model to begin with. So practically these involves heuristic transformation guessing viewing point and viewing angle changes, and optimizing for a set of transformations that reduce the difference between two images the most.

in claim 13, We extend background merging/concatenation from tow videos to many videos in a nearby locality. Where the nearby can be defined as backgrounds of these videos having substantial overlapping fields thus can be easily merged and concatenated into large continuous background. So this define nearby may not necessary centered around original two videos, but with a “continuity” transitional nature, such as: if A near B, B near C, C near D, this whole ground consider be “nearby” in our definition, but independently, A and D may not considered as “nearby” in dictionary sense. So this “nearby locality” is specifically defined to create continuous large merged background database as is the essence of the claim.

The following are the comments for the claims. I found it helps me to write the claims, wish it helps a Judge to read the claims too.

Claim 1-7: Single video background extraction and sharing in time dimension.

Claim 8-12: Multiple videos backgrounds concatenation, merging and sharing, to achieving information transfer between videos and information gaining.

Claim 13-14: concatenate backgrounds of many videos to form a large database of background (without high variant components such as people, vehicles)

Claim 15: Lost and Found Application.

Claim 16: Natural language representation generation: Generating structure of an video, recognizing elements in the structure with natural language names and pattern of names, serialize the recognized elements into natural language.

Claim 17-19: Device claim: multiple resolutions video capturing device.

### REFERENCES

1: Video Factorization By Temporal Stability and Spatial Resolutions, Jan. 9, 2014, USPTO No. 61/925628

2: Exception coding of information, Aug. 31, 2013, USPTO App No. 61/872677 by Zhong Yuan Ran.

3: Method and device for information processing based on inhibition. Aug. 12, 2013, USPTO App No. 61/865097 by Zhong Yuan Ran

4 Context based computing, Oct. 6, 3013, by Zhong Yuan Ran

5 Context based computing II, Oct. 18, 3013, by Zhong Yuan Ran

What is claimed is:

1. a method of processing video information, the method comprising: clustering image information in a video by similarity with viewing point and viewing angle normalization transformations, calculating temporal variation frequency of resulting clusters, sharing temporal invariant clusters along temporal dimension of said video.

2. method in claim 1, wherein multiple resolutions of same information source can be generated from image information of said video, said clustering by similarity biased for lower resolution preceding higher resolutions.

3. method in claim 2, wherein said video contain at least two resolutions of image information captured by two set of photo sensors toward the same scene, said two set of photo sensors are configured to have substantially different viewing angle resolutions.

4. method in claim 1, the method further comprising: designating at least one said temporal invariant cluster as background.

5. method in claim 2, the method further comprising: designating at least one said temporal invariant cluster as background.

6. method in claim 4, wherein said viewing point and viewing angle normalization producing a set of discrete viewing points and viewing angles, the method further comprising: clustering and sharing of backgrounds from different said discrete viewing points and discrete viewing angles.

7. method in claim 5, wherein said viewing point and viewing angle normalization producing a set of discrete viewing points and viewing angles, the method further comprising: clustering and sharing backgrounds from different said discrete viewing points and discrete viewing angles.

8. a method of merging backgrounds of two videos, the method comprising: extracting at least one background of each said two videos respectively, judging said two backgrounds as having one or more overlapping fields, merging said two overlapping background with viewing point and viewing angle normalization transformations.

9. method in claim 8, said judging of two backgrounds having one or more overlapping fields comprising: performing viewing point and viewing angle normalization transformations on said two backgrounds, judging good image matching on significant portion of said transformed backgrounds as having overlapping fields.

10. method in claim 8, said two videos having location information, said judging of two backgrounds having one or more overlapping fields comprising: judging two videos are taken from substantially same location based on said location information.

11. method in claim 8, said judging of two backgrounds having one or more overlapping fields comprising: judging good image matching on significant portion of said backgrounds as having overlapping fields on multiple resolutions of the background images biased for matching lower resolution preceding matching higher resolution.

12. method in claim 10, the method further comprising: collecting additional videos in a locality near location of said two videos, extracting backgrounds of said collected videos, concatenating said extracted backgrounds with shared fields.

13. method in claim 12, wherein at least one said concatenated backgrounds forms a continuous background with background information from at least 10,000 videos.

14. method in claim 8, the method further comprising: identifying high variant portion on overlapping fields of the backgrounds, highlighting said high variant portion as point of interest.

15. method in claim 1, the methods further comprising: recognizing backgrounds from a background database, recognizing each clusters from a named object database, recognizing relationship between items from a group consisting of said recognized objects, said recognized background from a database of patterned relationship, said pattern relationship having natural language representation, representing recognized objects and relationship in natural language.

16. method in claim 2, the methods further comprising: recognizing backgrounds from a background database, recognizing each clusters from a named object database, recognizing relationship between items from a group consisting of said recognized objects, said recognized background from a database of patterned relationship, said pattern relationship having natural language representation, representing recognized objects and relationship in natural language.

17. a video capturing device, the device comprising: at least two set of photo sensors with substantially different viewing angle resolutions, packaged at substantially same viewing point, with viewing field of lower resolution of said set of sensors substantially cover the viewing field of the higher resolution of said set of sensors, whereby two resolutions of the same visual information sources can be captured independently, packed as one coherent video to facilitate multiple resolution processing of said video and background extraction of said video.

18. device of claim 17, said two set of sensors are configured to work with two separate lenses and having separate power controls.

19. device in claim 17, wherein video information captured by said two set of sensors are synchronized.
